(19) United States
(12) Patent Application Publication
(10) Pub. No.: US 2001/0011879 A1
(43) Pub. Date: Aug. 9, 2001

(54) Multi-speed motor control

(76) Inventor: David M. Erdman, Fort Wayne, IN (US)

Correspondence Address: JOHN S. BEULICK, C/O ARMSTRONG TEASDALE, LLP, ONE METROPOLITAN SQUARE, SUITE 2600, ST LOUIS, MO, 63102-2740, US

(21) Appl. No.: 09/681,259

(22) Filed: Mar. 9, 2001

Related U.S. Application Data
(60) Provisional application No. 60/188,083, filed on Mar. 9, 2000.

(51) Int. Cl. H02P 1/38; H02P 3/18; H02P 5/28; H02P 7/48

(52) U.S. Cl. 318/773

(57) ABSTRACT

A motor speed control circuit generates a half cycle waveform and applies the half-cycle waveform to the motor at a controlled frequency to achieve speed reduction in the motor without motor modification. The circuit includes a rectifier bridge electrically connected to a power source and the motor terminals, a polarity sensing circuit electrically connected to the power source, a frequency reducing circuit coupled to the polarity sensing circuit and a bridge enabling circuit coupled to the frequency reducing circuit and to the rectifier bridge. For example, a one speed induction motor can effectively operate at two speeds using the c

### CROSS REFERENCE TO RELATED APPLICATIONS

This application claims the benefit of U.S. Provisional Application No. 60/188,083, filed Mar. 9, 2000.

### BACKGROUND OF INVENTION

This invention relates generally to motor drive systems and, more particularly, to electronic controls for motor drive systems that enable a motor to be operated at additional speeds.

In many applications of motor drive systems, multi-speed operation of the motor is advantageous. For instance, washing machines often utilize dual speed motors to execute wash and spin cycles. However, it may be more advantageous to use a three speed motor in certain applications, such, as for example, a washing machine, to further improve the performance of machine cycles. In other cases, it may be desirable to operate a single speed motor at more than one speed.

An additional speed could be achieved in a given motor with modification of the motor winding structure, such as by adding sets of windings with different numbers of poles. However, modification of motor windings is time intensive and undesirably affects the size and cost of the motor. Specifically, adding a lower speed to the motor increases size and cost of the motor.

Variable frequency phase inverters could be used to produce multi-speed motors, such as a three-speed motor, but variable frequency phase inverters however, are also expensive.

Accordingly, it would be desirable to provide a low cost motor control system that allows motor operation at additional lower speeds without modification of the motor itself.

### SUMMARY OF INVENTION

In an exemplary embodiment of the invention, a motor speed control circuit generates a complete, half-cycle waveform from an AC power source at a reduced frequency and energizes motor windings of an associated motor with the half-cycle waveform. A rectifier bridge within the speed control circuit is electrically connected to an AC power source and the motor terminals. A polarity sensing circuit within the speed control circuit is electrically connected to the AC power source and serves to generate a polarity based signal. The polarity based signal is applied to a frequency reducing circuit within the speed control circuit. The frequency reducing circuit is configured to produce bridge enabling signals to be applied to a bridge circuit. In alternative embodiments, the frequency reducing circuit employs flip-flop circuits and additional flip-flops can be used to further reduce frequency of the polarity based signal. Bridge enabling signals coupled into the bridge enabling circuit enable the rectifier bridge, allowing cycles of the AC line current to be applied to the motor. In alternative embodiments, the bridge circuit is one of a silicon controlled rectifier (SCR) bridge, a field effect transistor bridge and an insulated gate bipolar transistor bridge.

By generating, for example, complete half-cycle waveforms, voltage applied to the motor is reduced. Thus, using the control circuit, a one speed motor can be operated in a second speed lower than the designed speed, a dual speed motor can be operated in a third speed that is intermediate the low and high speeds of the motor, etc. Thus, a given motor can be operated in multiple speeds beyond conventional design speeds without modifying the motor windings, and without the use of frequency inverters. In one embodiment, the control circuit is used in conjunction with a two pole/four pole, double speed, permanent split capacitor (PSC) motor drive system to operate a two speed motor in a third speed. Therefore, for example, a three speed washing machine is realized with a two speed motor without expensive modifications to the motor.

### BRIEF DESCRIPTION OF DRAWINGS

FIG. 1 is a side elevational, partially broken away view of an exemplary washing machine including a clutchless drive system.

FIG. 2 is a front perspective view of a motor for the clutchless motor drive system shown in FIG. 1.

FIG. 3 is a partial perspective view of the motor shown in FIG. 2.

FIG. 4 is a schematic diagram of a control circuit for the motor shown in FIGS. 2 and 3.

FIG. 5 illustrates motor power waveforms with and without the control circuit shown in FIG. 4.

FIG. 6 is a performance comparison chart of an exemplary motor operated with and without the control circuit shown in FIG. 4.

FIG. 7 is a performance comparison chart similar to FIG. 6, but illustrates performance of another exemplary motor.

FIG. 8 is an exemplary schematic showing the control circuit shown in FIG. 4 connected to a motor.

### DETAILED DESCRIPTION

The control circuit of the present invention may be employed in a large variety of applications, and the resultant benefits accrue well beyond the application to a washing machine described and illustrated herein. It is contemplated that the invention could be used in a wide variety of applications in which multi-speed operation of a single phase induction motor is desirable. For example, the invention may be practiced in other household appliances, including but not limited to clothes dryers and dishwashers, as well as non-appliance applications. Therefore, the specific application described herein is for illustrative purposes only and is not intended to limit the invention is any aspect.

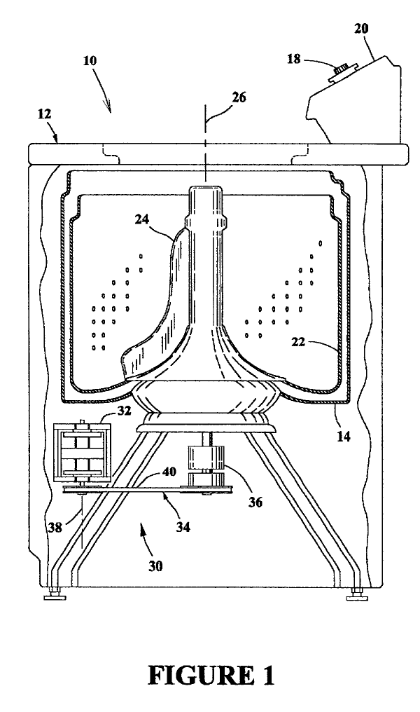

FIG. 1 is a partially broken away view of a conventional vertical axis washing machine 10, the construction and operation of which is well known in the art, and in which the present invention may be practiced. Washing machine 10 includes a cabinet housing 12 including an outer tub 14 adapted to be filled with wash water or rinse water through a fill tube (not shown) in response to manipulation of controls 18 located on a control panel 20 for user selection of desired machine cycles.

A clothes basket 22 is mounted within outer tub 14 and clothes disposed in clothes basket 22 are subjected to washing action by an oscillating agitator 24 located within clothes basket 22 during a wash or rinse cycle after introduction of water into outer tub 14. After each wash or rinse cycle agitation, clothes basket 22 is rotated about a longitudinal axis 26 at high speed in order to extract water from the clothes. The water is drained into a sump (not shown), and pumped to a drain (not shown) by a pump assembly (not shown).

Agitator 24 and clothes basket 22 are driven by a clutchless motor drive assembly 30 including a drive motor 32, a pulley system 34 and a known transmission 36 coupled to agitator 24 and clothes basket 22. Clutchless motor drive assembly 30 is operatively connected to control panel 20 and executes selected wash and rinse cycles of machine 10. In one embodiment, motor 32 is a dual speed, two pole/four pole, permanent split capacitor (PSC) electric AC induction motor including a vertical longitudinal axis 38 that is substantially parallel to and offset from clothes basket longitudinal axis 26 for driving transmission of clothes basket 22 via a transmission belt 40. Transmission 36 includes known speed reducing elements (not shown) and is normally braked by a spring applied disk brake (not shown) engaged by a brake cam actuator assembly (not shown) so that agitator 24 rotates while clothes basket 22 remains stationary. Whenever clothes basket 22 is to be rotated for centrifugal extraction of liquid from clothes in clothes basket 22, the brake cam actuator assembly releases the disk brake, allowing agitator 24 and clothes basket 22 to spin together.

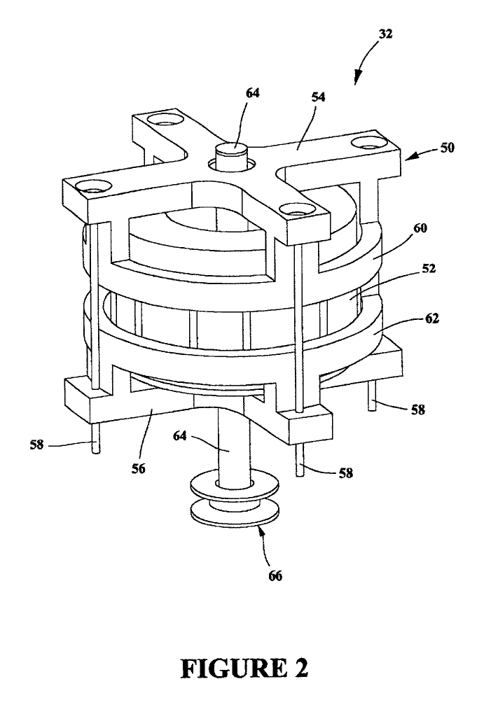

FIG. 2 is a perspective view of PSC motor 32 including a frame 50 and a stator assembly 52 having a start or auxiliary winding (not shown in FIG. 2) and a main winding (not shown in FIG. 2) positioned therein and electrically connected in parallel. A capacitor (not shown in FIG. 2) is permanently connected in series with the start or auxiliary winding. Frame 50 includes upper and lower cross-shaped members 54, 56 connected by a plurality of fastener members 58 that extend through openings (not shown in FIG. 2) for fastening to washing machine cabinet housing 12 (shown in FIG. 1). Annular portions 60, 62 extend from upper and lower cross-shaped members 54, 56, respectively, and circumscribe stator assembly 52. A rotor assembly (not shown in FIG. 2) is rotatably mounted and extends through a bore (not shown) in stator assembly 52. A motor output shaft 64 is coupled to the rotor assembly for rotary movement when the stator windings are energized. Motor output shaft 64 includes an integral pulley 66 for coupling to transmission 36 (shown in FIG. 1) with transmission belt 40 (shown in FIG. 1).

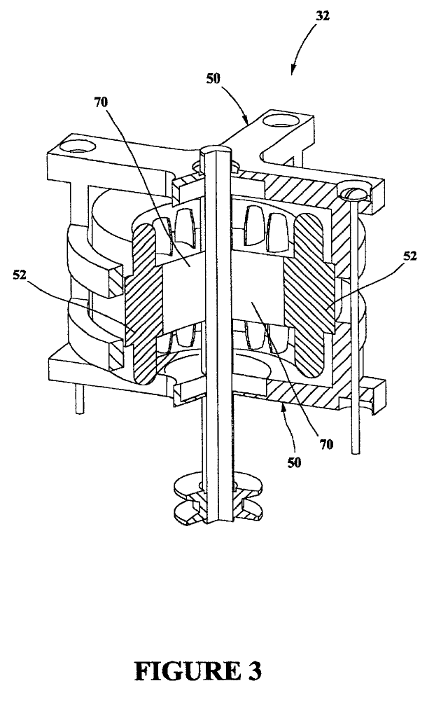

FIG. 3 is a broken away view of motor 32 illustrating rotor assembly 70 mounted within stator assembly 52 inside frame 50. Rotor assembly 70 has a high resistance to balance electromagnetic losses in the main and start windings. Therefore, a sufficient starting torque is generated with an acceptable temperature rise to allow starting of motor 32 without the use of slipping mechanisms to mechanically unload motor 32. Therefore, reliability concerns of known slipping clutch mechanisms are avoided.

Motor 32 generates sufficient torque to rotate clothes basket 22 (shown in FIG. 1) and/or agitator 24 (shown in FIG. 1) with an inrush current that is sufficiently low to avoid tripping of household circuit breakers and/or opening of household fuses. Therefore, washing machine 10 (shown in FIG. 1) may be powered by conventional residential power systems (not shown) without modification.

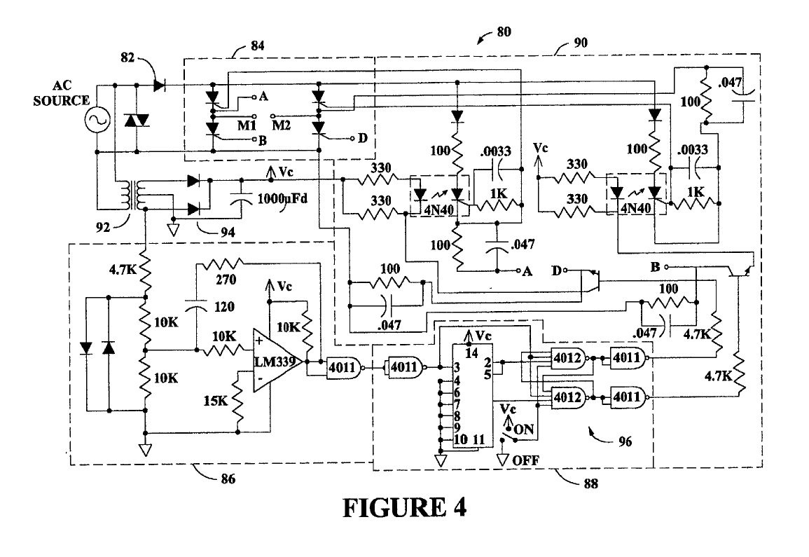

FIG. 4 is a circuit schematic of a control circuit 80 for operating a motor, such as motor 32 (shown in FIGS. 1-3), at multiple speeds. Control circuit 80 includes a rectifier 82, a silicon controlled rectifier (SCR) bridge 84, a comparator based polarity sensing circuit 86, a frequency reducing circuit 88 and a bridge enabling circuit 90. As shown in the Figure, a polarity sensing circuit 86 is configured to be connected to the AC power source through a step down transformer 92. Step down transformer 92 also supplies power to a full-wave rectifier circuit 94 which supplies power to polarity sensing circuit 86, frequency reducing circuit 88 and bridge enabling circuit 90.

Polarity sensing circuit 86 senses a polarity of AC power, and therefore is active for only one-half of the AC power waveform, producing a polarity based signal. The polarity based signal is applied to frequency reducing circuit 88, which in the embodiment shown, includes a flip-flop that divides the frequency of the polarity based signal by two. Frequency reducing circuit 88 includes further logic circuitry 96 to produce two logically opposite signals which change state whenever the flip-flop triggers. The logically opposite signals are applied to bridge enabling circuit 90, which turns on the SCRs which comprise bridge circuit 84 at a frequency that is one half of the frequency of the AC power that is rectified by rectifier 82 and applied to SCR bridge 84. AC power is transferred through SCR bridge 84 and coupled to motor 32 (not shown in FIG. 4) via SCR bridge center terminals M1 and M2. Other solid state switches could be employed in alternative embodiments of a bridge circuit, such as field effect transistors (FETS) or insulated gate bipolar transistors (IGBTs), in cooperation with circuit 80.

Circuit 80 is configured to select an appropriate half-cycle of the AC power source to apply to motor 32. The half-cycle waveform is applied to SCR bridge 84, and appropriate logic, as described above, is used to control the energy applied to the windings of motor 32 accordingly. Therefore, motor 32 is energized with complete half-cycles of AC voltage, and the SCRs are turned off when the polarity of the AC power source is different than the polarity of signal that polarity sensing circuit 86 is configured to sense. By using half-cycle waveforms, at a reduced frequency, to power motor 32 voltage applied to motor 32 is reduced proportionally.

In alternative embodiments, additional flip-flops (not shown) are added to frequency reducing circuit 88 to further subdivide the frequency of the AC power source. For example, adding another similar flip-flop to the embodiment shown in FIG. 4 would reduce the frequency by one half again, resulting in a frequency equal to one fourth the frequency of the AC line. In a further alternative embodiment, additional flip-flops could be switched in and out of the control circuit to selectively reduce the frequency by different multiples, and hence selectively vary the corresponding speed of motor 32, as explained below.

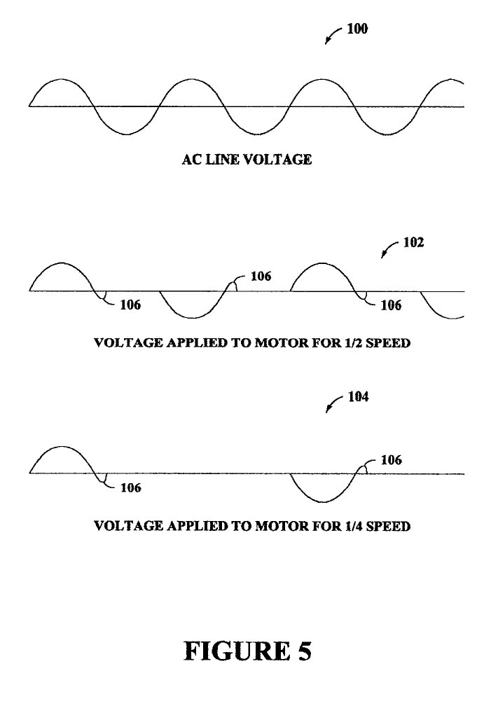

FIG. 5 illustrates exemplary waveforms generated by control circuit 80 (shown in FIG. 4) for powering a motor at one half speed or one quarter speed. Waveform 100 is a reference AC line waveform. A half-cycle waveform 102 has reduced frequency that is a common fraction of AC line waveform frequency as determined by control circuit 80 (shown in FIG. 4). Again, the effect of reducing the frequency of the half-cycle waveform applied to motor 32, is to reduce proportionally, the voltage applied to motor 32. A quarter cycle waveform 104 shows the effect of a second flip-flop being added to circuit 80. Waveforms 102 and 104 further indicate windings discharge 106, present for a short duration after control circuit 80 has removed power from motor 32.

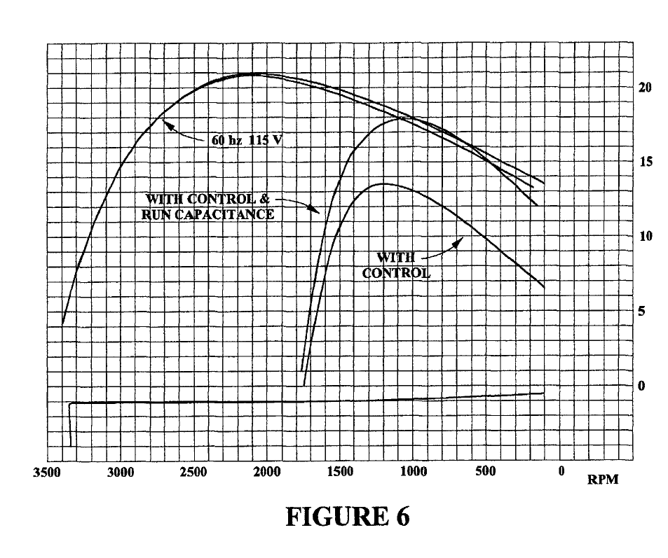

While control circuit 80 is heretofore described and illustrated in conjunction with two pole/four pole double speed PSC motor, it is also effective with other types of induction motors with varying numbers of poles, configurations and constructions. In other words, the invention is not limited to PSC motors. For example, FIG. 6 illustrates an exemplary two pole single speed capacitor run motor operated using an unaltered 115 VAC, 60 Hz line, i.e., without the benefit of control circuit 80 (shown in FIG. 4), and the same motor operated with control circuit 80 using two different run capacitors. As can be seen, the motor operates at about half speed when control circuit 80 is used, and effectively provides the two pole motor with the performance of a four pole motor due to the half-cycle 30 Hz input to the motor.

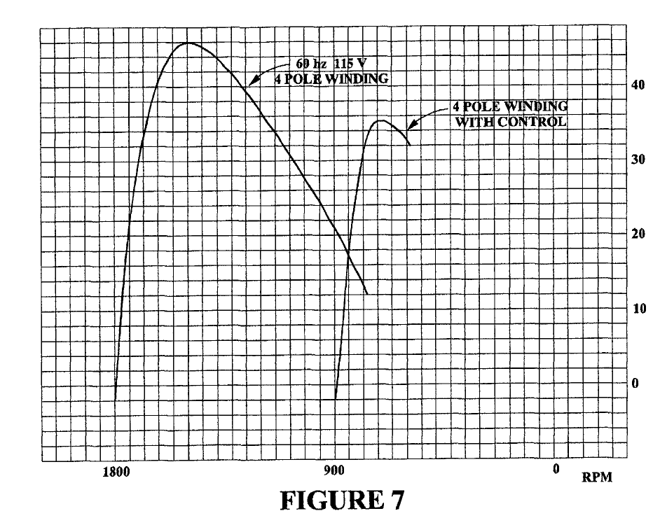

FIG. 7 is another illustration similar to FIG. 7 but showing the operation of a control circuit with an exemplary dual speed four pole/six pole motor. Again, control circuit 80 (shown in FIG. 4) operates the motor at about half speed of the motor without control circuit 80.

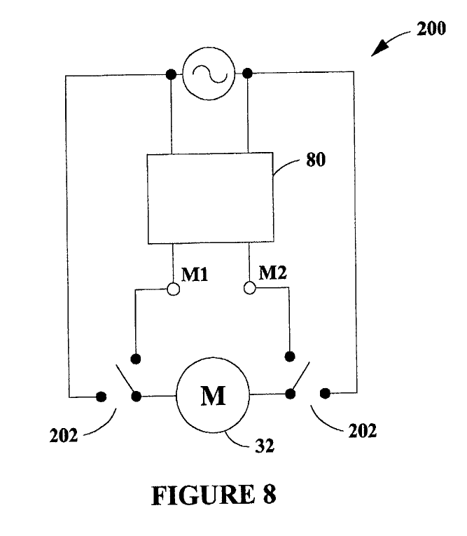

FIG. 8 is an exemplary schematic of a motor control system 200 which includes control circuit 80 (shown in detail in FIG. 4) connected to a motor, such as motor 32 (shown in FIGS. 1-3) using relays 202 to connect control circuit 80 to motor 32. Relays 202 are configured to switch the power supplied to motor 32 from that supplied by control circuit 80 to that supplied by the AC power source. In alternative embodiments of system 200, the function provided by relays 202 is supplied by any switching device capable of switching the motor supply voltages, including mechanical switches and solid state switching devices.

The motor speed control circuit herein described provides an inexpensive way to provide multiple speeds from a motor without the expense and manufacturing time inherent in existing multiple speed motor designs. Namely, use of the motor speed control circuit does not require, modification of the motor winding structure, such as by adding sets of windings with different numbers of poles, which exist in known multiple speed motor designs. Since modification of motor windings is time intensive and undesirably affects the size and cost of the motor, a motor speed control circuit is an inexpensive and desirable solution for adding a lower speed to the motor without increases in size and cost of the motor.

While the invention has been described in terms of various specific embodiments, those skilled in the art will recognize that the invention can be practiced with modification within the spirit and scope of the claims.

1. A motor speed control circuit comprising:
a rectifier bridge electrically connected to an AC power source and the motor terminals;
a polarity sensing circuit electrically connected to the AC power source;
a frequency reducing circuit coupled to said polarity sensing circuit; and
a bridge enabling circuit coupled to said frequency reducing circuit and to said rectifier bridge.

2. A motor speed control circuit in accordance with claim 1 wherein said polarity sensing circuit is configured to sense polarity of the AC power source applied to the bridge circuit to produce a polarity based signal.

3. A motor speed control circuit in accordance with claim 1 wherein said frequency reducing circuit is configured to produce bridge enabling signals to be applied to said bridge circuit.

4. A motor speed control circuit in accordance with claim 1 wherein said frequency reducing circuit comprises at least one flip-flop circuit.

5. A motor speed control circuit in accordance with claim 4 wherein said flip-flop circuit is configured to cause the AC frequency applied to the motor to be one-half of the frequency of the AC voltage source.

6. A motor speed control circuit in accordance with claim 4 wherein said flip-flop circuit is configured to cause the AC frequency applied to the motor to be one-fourth of the frequency of the AC voltage source.

7. A motor speed control circuit in accordance with claim 1 wherein said bridge circuit is one of a silicon controlled rectifier (SCR) bridge, a field effect transistor bridge and an insulated gate bipolar transistor bridge.

8. A method for reducing the speed of an electric motor using a motor speed control circuit, said method comprising the steps of:
switching the motor terminals from an AC line power source to an AC power source present at an output of the control circuit; and
reducing a frequency of the voltage applied to the motor using the control circuit.

9. A method in accordance with claim 8, wherein said step of switching the motor terminals comprises the step of electrically connecting the motor terminals to an output of a bridge circuit within the control circuit.

10. A method in accordance with claim 8, wherein said step of reducing a frequency comprises the steps of:
sensing a polarity of the AC voltage applied to the bridge circuit to produce a polarity based signal;
applying the polarity based signal to a frequency reducing circuit to produce bridge enabling signals; and
applying the bridge enabling signals to the bridge circuit.

11. A method in accordance with claim 10 wherein said step of applying the polarity based signal to a frequency reducing circuit comprises the step of applying the polarity based signal to a flip-flop circuit.

12. A method in accordance with claim 11 wherein the flip-flop circuit causes the AC frequency applied to the motor to be one-half of an AC voltage source.

13. A method in accordance with claim 11 wherein the flip-flop circuit causes the AC frequency applied to the motor to be one-fourth of an AC voltage source.

14. A method in accordance with claim 8 wherein the bridge circuit is one of a silicon controlled rectifier (SCR) bridge, a field effect transistor bridge and an insulated gate bipolar transistor bridge.

15. A multiple speed motor system comprising:
an AC motor;
a motor speed control circuit configured to reduce the frequency of a power source applied to said motor; and
a switching circuit configured to switch AC power applied to said motor from a AC line power source to an AC power source present at an output of said control circuit.

16. A motor system in accordance with claim 15 wherein said motor is one of a permanent split capacitor motor and an induction motor.

17. A motor system in accordance with claim 15 wherein said motor speed control circuit comprises:
a rectifier bridge electrically connected to an AC power source and the motor terminals;
a polarity sensing circuit electrically connected to the AC power source;
a frequency reducing circuit coupled to said polarity sensing circuit; and
a bridge enabling circuit coupled to said frequency reducing circuit and to said rectifier bridge, said polarity sensing circuit configured to sense polarity of the AC power source applied to said bridge circuit to produce a polarity based signal, said frequency reducing circuit configured to produce bridge enabling signals to be applied to said bridge circuit.

18. A motor system in accordance with claim 17 wherein said frequency reducing circuit comprises at least one flip-flop circuit, said flip-flop circuit configured to cause the AC frequency applied to the motor to be one-half of the frequency of the AC voltage source.

19. A motor system in accordance with claim 17 wherein said frequency reducing circuit comprises at least one flip-flop circuit, said flip-flop circuit configured to cause the AC frequency applied to the motor to be one-fourth of the frequency of the AC voltage source.

20. A motor system in accordance with claim 17 wherein said bridge circuit is one of a silicon controlled rectifier bridge, a field effect transistor bridge and an insulated gate bipolar transistor bridge.
